(19) United States
(12) Patent Application Publication
(10) Pub. No.: US 2011/0017817 A1
(43) Pub. Date: Jan. 27, 2011

(54) DELIVERY INFORMATION SYSTEM AND METHOD THEREFOR

(76) Inventors: Bradley W. Belt, Peoria, AZ (US); L. Mathew Drage, Cottonwood, AZ (US); Christopher J. Osborn, Cornville, AZ (US); Henri Prud'homme, Clarkdale, AZ (US); Devra Smith, Chandler, AZ (US)

Correspondence Address: WEISS & MOY PC, 4204 NORTH BROWN AVENUE, SCOTTSDALE, AZ, 85251, US

(21) Appl. No.: 12/508,839

(22) Filed: Jul. 24, 2009

(51) Int. Cl. G06F 17/00; G01C 21/00

(52) U.S. Cl. 235/375; 701/204

(57) ABSTRACT

A transportation delivery system has a computer system for entering shipping information and generating a physical delivery ticket and an electronic delivery ticket. The electronic delivery ticket is stored in an electronic media. A plurality of point of delivery units is positioned in different delivery locations and in communication with the computer system. Each point of delivery unit is associated with a specific delivery location and is able to scan the physical delivery ticket to obtain shipping information on the physical delivery ticket. The obtained shipping information is sent to the computer system via a communication network to update the electronic ticket and to bill a proper recipient.

### FIELD OF THE INVENTION

This invention relates to the trucking industry, and, more specifically, to a trucking information delivery system to provide the trucking company and the customer with product shipment, delivery, and other information.

### BACKGROUND OF THE INVENTION

Trucking companies rely upon numerous drivers to support the transportation of goods to various sites. When a truck is loaded with goods, related shipping documents are generated and given to the driver. Upon delivery of the goods to the proper designation, the driver must obtain the consignee's signature on the shipping document as evidence of the delivery. If a driver has taken the goods to a wrong location, the driver cannot deliver the goods and must transport the goods to the proper location and must obtain the consignee's signature on the shipping document as evidence of the delivery.

In general, most transportation companies cannot bill the receiving party for the rendered transportation services until the signed shipping documents are received by the billing department of the transportation company. Because of the above issue, numerous different approaches have been proposed to expedite the delivery of the signed shipping documents.

One proposal has been for the transportation companies to provide terminals where drivers can drop off the signed shipping documents. These terminals would be provided at various locations throughout the country. Driver would locate the closest terminal and send the documents to the billing department of the transportation company via the terminals. However, inevitably, some of the terminals are located in remote geographic areas, making convenient or efficient access difficult. Moreover, few transportation companies even have the resources to operate and maintain an extensive network of terminals

Another proposal has been to provide scanning service centers or scanning kiosks at truck stop locations throughout the country. At each scanning service center or kiosks, signed shipping documents are scanned into the document delivery system and transmitted to a central data center. The scanned documents and other data are stored on the central server and can be retrieved by the recipients whose address was entered or read during the scanning process. While beneficial, such a document delivery system can be costly because it requires installation, maintenance and service. Furthermore, the scanning process can be time consuming because each shipping document must be properly positioned and scanned.

Therefore, a need existed to provide a system and method to overcome the above problem.

### SUMMARY OF THE INVENTION

In accordance with one embodiment of the present invention, a transportation delivery system has a computer system for entering shipping information and generating a physical delivery ticket and an electronic delivery ticket. The electronic delivery ticket is stored in an electronic media. A plurality of point of delivery units is positioned in different delivery locations and in communication with the computer system. Each point of delivery unit is associated with a specific delivery location and is able to scan the physical delivery ticket to obtain shipping information on the physical delivery ticket. The obtained shipping information is sent to the computer system via a communication network to update the electronic ticket and to bill a proper recipient.

In accordance with another embodiment of the present invention, a transportation delivery system has a computer system for entering shipping information and generating a physical delivery ticket and an electronic delivery ticket. The electronic delivery ticketed stored in an electronic media. A plurality of point of delivery units is positioned in different delivery locations and in communication with the computer system. Each point of delivery unit is associated with a specific delivery location and is able to scan the physical delivery ticket to obtain shipping information on the physical delivery ticket. The obtained shipping information is sent to the computer system via a communication network to update the electronic ticket and to bill a proper recipient. Each electronic ticket is displayed on the computer system and on at least one of the point of delivery units and shows at least a plurality of: a Ticket Number, Loading Terminal, Contents of Shipment, Weight of Shipment, Time and Date of Shipment, Carrier of Contents, Truck ID, Estimated Time of Arrival, Status of shipment. The computer system determines which electronic ticket is displayed on which point of delivery unit.

In accordance with another embodiment of the present invention, a transportation delivery system has a computer system for entering shipping information and generating a physical delivery ticket and an electronic delivery ticket. The electronic delivery ticketed stored in an electronic media. A plurality of point of delivery units is positioned in different delivery locations and in communication with the computer system. Each point of delivery unit is associated with a specific delivery location and is able to scan the physical delivery ticket to obtain shipping information on the physical delivery ticket. The obtained shipping information is sent to the computer system via a communication network to update the electronic ticket and to bill a proper recipient. Each electronic ticket is displayed on the computer system and on at least one of the point of delivery units and shows at least a plurality of: a Ticket Number, Loading Terminal, Contents of Shipment, Weight of Shipment, Time and Date of Shipment, Carrier of Contents, Truck ID, Estimated Time of Arrival, Status of shipment. The computer system determines which electronic ticket is displayed on which point of delivery unit. The computer system animates information on the electronic tickets displayed on the at least one of the point of delivery units when the information changes. The computer system sends out notifications to specific delivery locations. The notifications being at least one of: a delay notification to indicate a delayed and provide a new ETA; a diverted notification to indicate shipment has been diverted to another party and that intended recipient will not be billed and that a new shipment may be delivered if desired, or a confirmation notification to indicate that a shipment has been loaded and will be transported.

The present invention is best understood by reference to the following detailed description when read in conjunction with the accompanying drawings.

### BRIEF DESCRIPTION OF THE DRAWINGS

FIG. 1 is a simplified block diagram of the delivery information system;

FIG. 2 is an elevated perspective view of the point of delivery unit of the delivery information system;

FIG. 3 is an elevated perspective view of the point of delivery unit showing the components of the scanning unit;

FIG. 4 is a front view of a display screen used in the delivery information system; and

FIG. 5 is a flowchart showing operation of the system shown in FIG. 1.

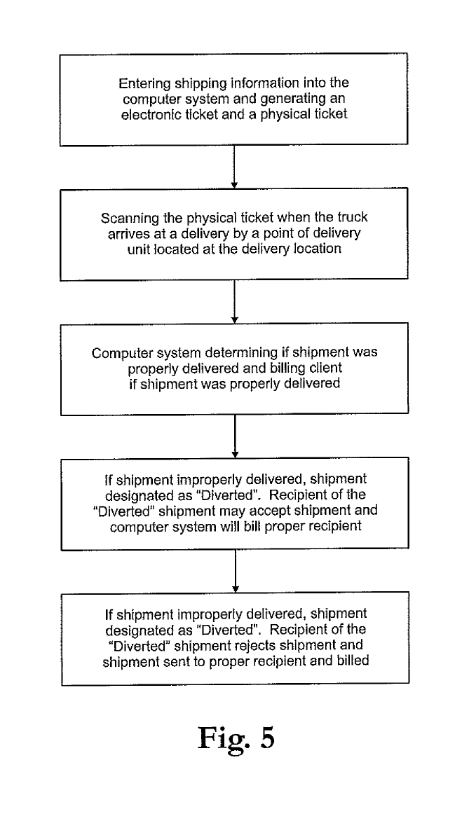

Common reference numerals are used throughout the drawings and detailed description to indicate like elements.

### DETAILED DESCRIPTION

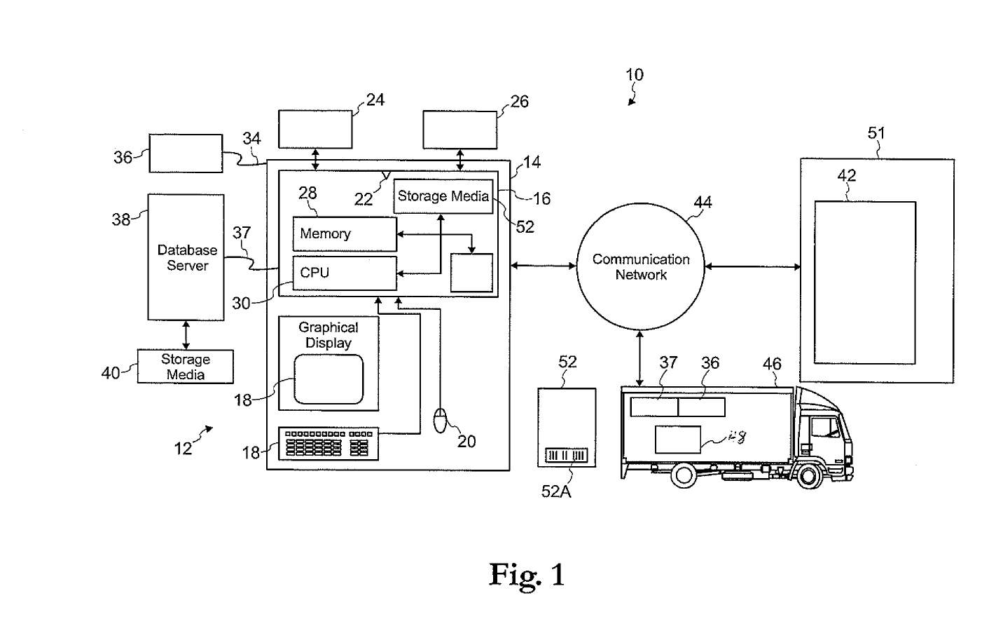

Referring to FIG. 1-4, a trucking information delivery system 10 (hereinafter system 10) will be described. The system 10 is used to provide billing and delivery information to the trucking company and its customers. The system 10 may include a main control unit 12. The main control unit 12 may include a computer system 14. The computer system 14 may have a processor unit 16 and a display 18. Input devices may be coupled to the processor unit 16. The input devices may be a keyboard 18, a mouse 20 and the like.

The processor unit 16 may further have an I/O port 22 for downloading data to the processor unit 16. The I/O port 22 may be a USB port, a FireWire port or the like. The listing of the above is given as an example and should not be seen as to limit the scope of the present invention. Alternatively, the processor unit 16 may have a reading device 24 coupled to the processor unit 16. The reading device 24 may be a memory card reader or the like. The processor unit 16 may further have a scanning device 26 coupled thereto. The scanning device 26 may be an image scanner, a bar code scanner, or the like. The scanning device 26 may also be used to download data to the processor unit.

Through the execution of program instructions forming a computer program product within the computer system 14, the computer system 14 may provide a means for providing the trucking company and its customer with product shipment, delivery, and other shipping information. The program instructions maybe located within a memory 28 of the processor unit 16 and executed by a central processing unit 30 (CPU). Any data generated and or gathered from the running of the program instructions such billing, delivery information, and the like may be stored within a storage media 32, memory 28, or the like. Alternatively, the computer system 14 may have a connection 34 to a database 36 to store the data generated.

The computer system 14 may further have a connection 37 to a network such as a local-area network (LAN), wide-area network (WAN) or the Internet. The connection 37 may be a wired connection, a wireless connection, or the like. In a network implementation, the program instructions may be located within a database server 38. Any data generated and or gathered from the running of the program instructions may be stored in a storage media 40 coupled to the database server 38.

The computer system 14 may be connected to one or more point of delivery units 42 via a communication network 44. The communication network 44 may be a wired or wireless network such as a landline network, a cable network, a cellular network, satellite network, or the like.

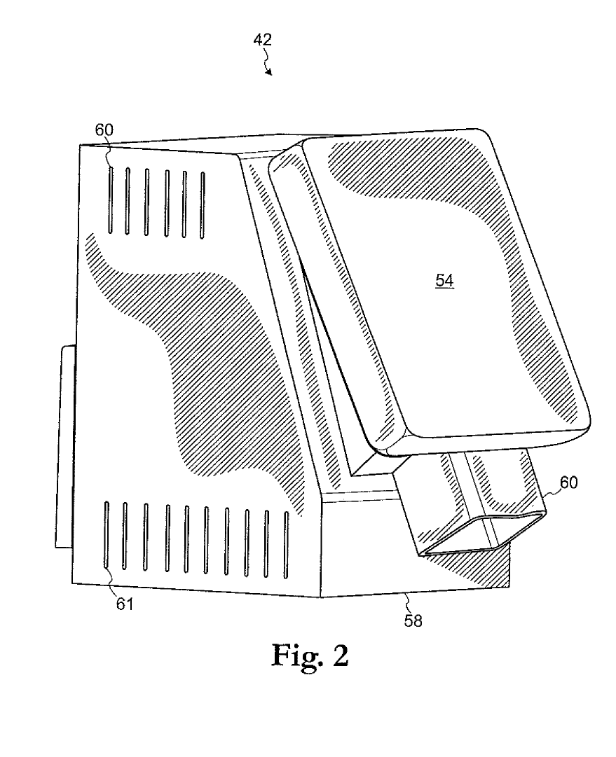

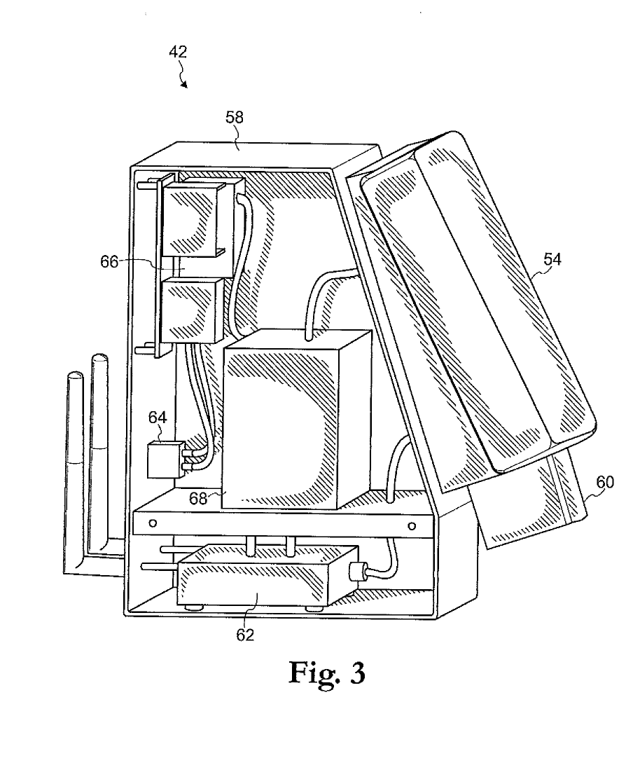

As seen more clearly in FIGS. 2-3, each point of delivery unit 42 may have an enclosure 58. The enclosure 58 may be used to house a plurality of different components of the point of delivery unit 42. The enclosure 58 may further be used to protect the different components from the environment. In accordance with one embodiment, the enclosure may have one or more vents 61. The vents 61 may be used to allow air to circulate through the enclosure 58 for cooling of the different components. The enclosure 58 may be formed of a lightweight and sturdy material such as aluminum, plastic, fiberglass or the like. The listing is given as an example and should not be seen as to limit the scope of the present invention.

A scanning device 60 may be attached to a front area of the enclosure 58. The scanning device 60 may be used to scan and read shipping information. In accordance with one embodiment, the scanning device 60 is a bar code reader. The scanning device 60 may have a display 54. The display 54 may be used to show the shipping information read by the scanning device 60 as well as to display other shipping information as will be discussed below.

A transmitter and receiver 62 may be positioned in the enclosure 58. The transmitter receiver 62 may be used by the point of delivery unit 42 to send and receive shipping data. The transmitter receiver 62 may further be programmed to be identified with a specific recipient. The transmitter receiver 62 may be coupled to the communication network 44 and to the scanning device 60. In accordance with one embodiment of the present invention, the transmitter receiver may be a cellular Virtual Private Network (VPN) device. A cellular VPN device utilizes public cellular telecommunications networks to conduct private data communications. This will allow the system 10 to use existing public cellular communication networks while providing enhanced security.

A power supply 64 may be positioned in the enclosure 58 and coupled to the transmitter receiver 62 and the scanning device 60. The power supply 64 is used for powering the different components of the point of delivery unit 42. In accordance with one embodiment, the power supply 64 is AC power supply. The power supply 64 may be coupled to a power adapter 66. The power adapter 66 may be used to convert the voltage from the power supply 64 (i.e., wall outlet) to a different, usually a lower voltage to be used by the different components of the point of delivery unit 42.

A back-up power supply 68 may be positioned in the enclosure 58 and coupled to the transmitter receiver 62 and the scanning device 60. The back-up power supply 68 is used to provide power to the different components of the point of delivery unit 42 if the power supply 64 fails. In accordance with one embodiment, the power supply 64 is battery back-up power supply.

In operation, when a truck 46 is loaded with a shipment 48 at a loading terminal, the information is entered into the computer system 14 and an electronic ticket 50 and a physical ticket 52 are generated. The electronic ticket 50 may be stored in the computer system 14 or in the database 36 or database server 38. The electronic ticket 50 may be shown on a display 18 of the computer system 14 as well as on a display 54 on the point of delivery units 42. In accordance with one embodiment, the computer system 14 maybe programmed to control which electronic tickets 50 are shown on each display 54 on the different point of delivery units 42. Thus, in this embodiment, customers may only review electronic tickets 50 meant for that particular customer.

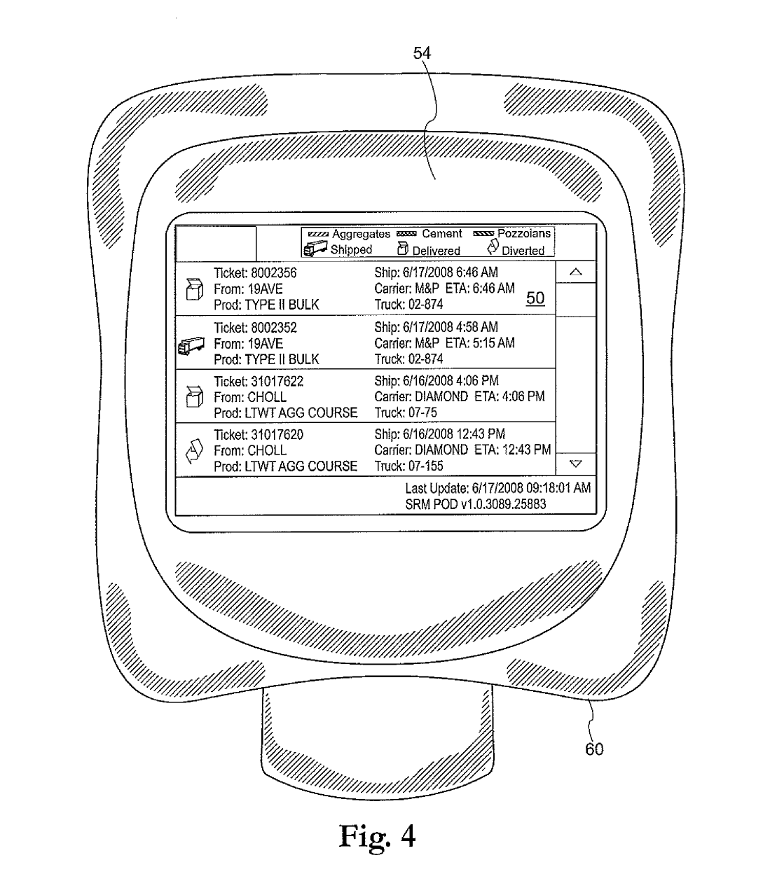

As shown most clearly in FIG. 4, each electronic ticket 50 will show detailed information related to each shipment. In accordance with one embodiment, each electronic ticket 50 may show information such as, but not limited to: Ticket Number, Loading Terminal, Contents of Shipment, Weight of Shipment, Time and Date of Shipment, Carrier of Contents, Truck ID, Estimated Time of Arrival, Status (Shipped, Delivered, and Diverted) and the like. For Status, once the electronic ticket So is generated, the Status line will read as “Shipped”. The information on the each electronic ticket 50 may be manipulated so that each customer may be able to customize the information displayed on the display 54 on the point of delivery unit 42. For example, each customer may wish to view all electronic tickets 50, electronic tickets 50 in transit, electronic tickets delivered, individual electronic tickets 50, etc. The information may further be manipulated and shown on split screens on the display 18 of the computer system 14 as well as on a display 54 on the point of delivery units 42.

Once the computer system 14 generates the electronic ticket 50 and the physical ticket 52, the computer system 14 may send out a confirmation notice to the recipient. The confirmation notice will indicate that the shipment has been loaded on the truck 46 and will be transported to the recipient. The confirmation may be an email, computer phone call, text message, and the like.

The computer system 14 may further calculate an Estimated Time of Arrival (ETA) for each electronic ticket 50 generated. The ETA for each electronic ticket 50 may be shown on the display 18 of the computer system 14 as well as on the display 54 on the point of delivery units 42. The ETA status may be updated at predetermined intervals and the updated ETA shown on the display 18 of the computer system 14 as well as on the display 54 on the point of delivery unit 42.

The ETA may be calculated based on different mapping programs loaded onto the computer system 14. Alternatively, each truck 46 may be equipped with a GPS unit 56. The GPS unit 56 will transmit location information which is sent to the computer system 14. The GPS unit 56 may transmit the location information to the computer system 14 through the communication network 44. The computer system 14 may then calculate the ETA using the different mapping programs loaded onto the computer system 14 thereby providing real time tracking of the shipment. The computer system 14 may further be used to show a map on the display 18 of the computer system 14 as well as on a display 54 of the point of delivery unit 42 so that a recipient may see the location of the shipment.

If for some reason the shipment is delayed (i.e., weather, mechanical issues with the truck 46, etc.), the computer system 14 may generate a delay notification to the recipient. The delay notification will indicate that the shipment has been delayed and provide a new ETA. The delay notification may be an email, computer phone call, text message, and the like.

When the truck 46 arrives at a delivery location 51, the physical ticket 52 is scanned by a point of delivery unit 42 located at the delivery location 51. As previously stated, each point of delivery unit 42 is associated with a specific delivery location 51. The physical ticket 52 may have an identification marker 52A. The identification marker 52A may have shipping information such as, but not limited to: Ticket Number, Contents of Shipment, Customer, and the like. In accordance with one embodiment, the identification marker 52A is a bar code.

In accordance with one embodiment, the identification marker 52A is scanned by the scanning device 60 of the point of delivery unit 42. Once scanned, the point of delivery unit 42 will transmit the delivery information to the computer system 14 where the computer system 14 will compare and update the shipping information. If the computer system 14 determines that the shipment 48 has been delivered to the proper delivery location 51, the computer system 14 will update the status shipping information as “Delivered” on the electronic ticket 50 and the recipient of the shipment 48 may be invoiced. However, if the computer system 14 determines that the shipment 48 has been improperly delivered, the computer system 14 will update the status shipping information as “Diverted” on the electronic ticket 50. In accordance with one embodiment, the status shipping information showing “Diverted” may flash, change colors, or have other animated characteristics.

If a shipment 48 has been improperly delivered and designated as “Diverted”, the recipient of the “Diverted” shipment 48 has multiple options. First, the recipient of the “Diverted” shipment 48 may accept the shipment. If the recipient of the “Diverted” shipment 48 accepts the shipment, this information is added into the point of delivery unit 42 and transferred into the computer system 14. The computer system 14 will update the shipping information so that the recipient of the “Diverted” shipment 48 is billed for the shipment 48.

The computer system 14 will then inform the intended recipient that the “Diverted” shipment 48 has been delivered to another party and that the intended recipient will not be billed. The computer system 14 may further inform the intended recipient when a new shipment may be expected. In accordance with one embodiment, the computer system 14 may in form the intended recipient that the “Diverted” shipment 48 has been delivered to another party by generating a diverted notification to the intended recipient. The diverted notification will indicate that the shipment has been diverted to another party and that the intended recipient will not be billed and that a new shipment may be delivered if desired. The computer system 14 may further inform the intended recipient when the new shipment may be expected and provide a new ETA. The notification may be an email, computer phone call, text message, and the like.

Alternatively, if the shipment 48 has been improperly delivered and designated as “Diverted”, the recipient of the “Diverted” shipment 48 may not accept the shipment 48. In this case, the driver of the truck 46 may obtain the correct delivery location and take the shipment 48 to the proper recipient. In accordance with one embodiment, the truck 42 may be equipped with a communication system 37. The communication system 37 may allow the driver to contact the shipping headquarters to obtain the proper delivery location. The communication system 37 may further be used for communication between the shipping headquarters and the driver to alter delivery shipments such as a need to divert a shipment 48 on the fly, update shipping information, and the like. The communication system 37 may be a two-way radio system, a cellular telephone system, or the like. Alternatively, the driver of the truck 46 may log into the computer system 14 to obtain the correct delivery location. The driver may log into the computer system 14 via the point of delivery unit 42, the communication system 37 or the like.

The computer system 14 will continuously monitor all electronic tickets 50. The computer system 14 may compile and send out detailed delivery reports to all recipients at designated time frames (i.e., once a week, once a month, quarterly, etc). The reports would summarize the activity for the designated time frame. For example, the reports may include information such as, but not limited to: total number of diversions, total amount of cargo delivered, received versus shipped information, in transit reports, etc.

This disclosure provides exemplary embodiments of the present invention. The scope of the present invention is not limited by these exemplary embodiments. Numerous variations, whether explicitly provided for by the specification or implied by the specification, such as variations in structure, dimension, type of material and manufacturing process may be implemented by one of skill in the art in view of this disclosure.

What is claimed is:

1. A transportation delivery system comprising:
a computer system for entering shipping information and generating a physical delivery ticket and an electronic delivery ticket, the electronic delivery ticketed stored in an electronic media; and
a plurality of point of delivery units positioned in different delivery locations and in communication with the computer system, wherein each point of delivery unit is associated with a specific delivery location and is able to scan the physical delivery ticket to obtain shipping information on the physical delivery ticket, the obtained shipping information sent to the computer system via a communication network to update the electronic ticket and to bill a proper recipient.

2. A transportation delivery system in accordance with claim 1 wherein one of the point of delivery units comprises:
a scanning unit for reading shipping information on the physical delivery ticket;
a transmitter receiving unit coupled to the scanning unit for transmitting the shipping information from the scanning unit and receiving the electronic ticket from the computer system; and
a power supply coupled to the scanning unit and the transmitter unit.

3. A transportation delivery system in accordance with claim 2 wherein the one of the point of delivery units further comprises a back-up power supply coupled to the scanning unit and the transmitter unit.

4. A transportation delivery system in accordance with claim 2 wherein the transmitter receiver is a Virtual Private Network (VPN) device.

5. A transportation delivery system in accordance with claim 2 wherein the one of the point of delivery units further comprises a display on the scanning unit for showing electronic tickets for a particular delivery location where the one of the point of delivery unit is located.

6. A transportation delivery system in accordance with claim 1 wherein each electronic ticket is displayed on the computer system and on at least one of the point of delivery units and shows at least a plurality of: a Ticket Number, Loading Terminal, Contents of Shipment, Weight of Shipment, Time and Date of Shipment, Carrier of Contents, Truck ID, Estimated Time of Arrival, Status of shipment.

7. A transportation delivery system in accordance with claim 6 wherein the computer system animates information on the electronic tickets displayed on the at least one of the point of delivery units when the information changes.

8. A transportation delivery system in accordance with claim 1 further comprising a GPS unit located on a truck delivering shipments to provide ETAs to a specific delivery location.

9. A transportation delivery system in accordance with claim 1 further comprising a GPS unit located on a truck delivering shipments and in communication with the computer system, the computer system using information transmitted by the GPS unit to calculate and provide an ETA to a specific delivery location.

10. A transportation delivery system in accordance with claim 1 wherein the computer system sends out notifications to specific delivery locations, the notifications being at least one of: a delay notification to indicate a delayed and provide a new ETA; a diverted notification to indicate shipment has been diverted to another party and that intended recipient will not be billed and that a new shipment maybe delivered if desired, or a confirmation notification to indicate that a shipment has been loaded and will be transported.

11. A transportation delivery system in accordance with claim 12 wherein the computer system sends out notifications sent out are one of an email, computer phone call, text message, and the like.

12. A transportation delivery system comprising:
a computer system for entering shipping information and generating a physical delivery ticket and an electronic delivery ticket, the electronic delivery ticketed stored in an electronic media; and
a plurality of point of delivery units positioned in different delivery locations and in communication with the computer system, wherein each point of delivery unit is associated with a specific delivery location and is able to scan the physical delivery ticket to obtain shipping information on the physical delivery ticket, the obtained shipping information sent to the computer system via a communication network to update the electronic ticket and to bill a proper recipient;
wherein each electronic ticket is displayed on the computer system and on at least one of the point of delivery units and shows at least a plurality of: a Ticket Number, Loading Terminal, Contents of Shipment, Weight of Shipment, Time and Date of Shipment, Carrier of Contents, Truck ID, Estimated Time of Arrival, Status of shipment, the computer system determining which electronic ticket is displayed on which point of delivery unit.

13. A transportation delivery system in accordance with claim 12 wherein one of the point of delivery units comprises:
a scanning unit for reading shipping information on the physical delivery ticket and having a display;
a transmitter receiving unit coupled to the scanning unit for transmitting the shipping information from the scanning unit and receiving electronic tickets from the computer system;
an AC power supply coupled to the scanning unit and the transmitter unit;
a regulator coupled to the AC power supply, the scanning unit and the transmitter unit; and
a back-up power supply coupled to the scanning unit and the transmitter unit.

14. A transportation delivery system in accordance with claim 13 wherein the transmitter receiver is a Virtual Private Network (VPN) device.

15. A transportation delivery system in accordance with claim 12 wherein the computer system animates information on the electronic tickets displayed on the at least one of the point of delivery units when the information changes.

16. A transportation delivery system in accordance with claim 12 further comprising a GPS unit located on a truck delivering shipments and in communication with the computer system, the computer system using information transmitted by the GPS unit to calculate and provide an ETA to a specific delivery location.

17. A transportation delivery system in accordance with claim 12 wherein the computer system sends out notifications to specific delivery locations, the'notifications being at least one of: a delay notification to indicate a delayed and provide a new ETA; a diverted notification to indicate shipment has been diverted to another party and that intended recipient will not be billed and that a new shipment may be delivered if desired, or a confirmation notification to indicate that a shipment has been loaded and will be transported.

18. A transportation delivery system comprising:
a computer system for entering shipping information and generating a physical delivery ticket and an electronic delivery ticket, the electronic delivery ticketed stored in an electronic media; and
a plurality of point of delivery units positioned in different delivery locations and in communication with the computer system, wherein each point of delivery unit is associated with a specific delivery location and is able to scan the physical delivery ticket to obtain shipping information on the physical delivery ticket, the obtained shipping information sent to the computer system via a communication network to update the electronic ticket and to bill a proper recipient;
wherein each electronic ticket is displayed on the computer system and on at least one of the point of delivery units and shows at least a plurality of: a Ticket Number, Loading Terminal, Contents of Shipment, Weight of Shipment, Time and Date of Shipment, Carrier of Contents, Truck ID, Estimated Time of Arrival, Status of shipment, the computer system determining which electronic ticket is displayed on which point of delivery unit, the computer system animates information on the electronic tickets displayed on the at least one of the point of delivery units when the information changes;
wherein the computer system sends out notifications to specific delivery locations, the notifications being at least one of: a delay notification to indicate a delayed and provide a new ETA; a diverted notification to indicate shipment has been diverted to another party and that intended recipient will not be billed and that a new shipment may be delivered if desired, or a confirmation notification to indicate that a shipment has been loaded and will be transported.

19. A transportation delivery system in accordance with claim 18 wherein one of the point of delivery units comprises:
a scanning unit for reading shipping information on the physical delivery ticket and having a display;
a transmitter receiving unit coupled to the scanning unit for transmitting the shipping information from the scanning unit and receiving electronic tickets from the computer system;
an AC power supply coupled to the scanning unit and the transmitter unit;
a regulator coupled to the AC power supply, the scanning unit and the transmitter unit; and
a back-up power supply coupled to the scanning unit and the transmitter unit.
wherein the transmitter receiver is a Virtual Private Network (VPN) device.

20. A transportation delivery system in accordance with claim 18 further comprising a GPS unit located on a truck delivering shipments and in communication with the computer system, the computer system using information transmitted by the GPS unit to calculate and provide an ETA to a specific delivery location.
